(19) United States
(12) Patent Application Publication
(10) Pub. No.: US 2003/0002498 A1
(43) Pub. Date: Jan. 2, 2003

(54) Column-based reconfigurable switching matrix

(76) Inventors: Marc Boulais, Dorval (CA); Gerard Auclair, St. Laurent (CA); Claude Dubreuil, Ste-Marthe-Sur-Le-Lac (CA)

Correspondence Address: F. Drexel Feeling, Esq., JONES, DAY, REAVIS & POGUE, North Point, 901 Lakeside Avenue, Cleveland, OH, 44114, US

(21) Appl. No.: 10/163,760

(22) Filed: Jun. 5, 2002

Related U.S. Application Data
(60) Provisional application No. 60/295,989, filed on Jun. 5, 2001.

(51) Int. Cl. H04J 1/16

(52) U.S. Cl. 370/389; 370/468; 370/229

(57) ABSTRACT

An improved switching device is provided. The switching device comprises a switching matrix and a cross-connection controller. The switching matrix receives a quantity of data wherein the quantity of data includes a plurality of payloads. A first payload and a second payload of the plurality of payloads are of different sizes. The matrix is operable to switch the first and the second payloads. The cross-connection controller provides switching instructions to the switching matrix. The controller receives payload identification information and connection point information and generates switching instructions in response to the payload identification information and the connection point information. The switching instructions are provided to the matrix to instruct the matrix on how to switch the first and second payloads.

### CROSS-REFERENCE TO RELATED APPLICATIONS

This application claims priority from and is related to U.S. Provisional Application No. 60/295,989 entitled “Column-Based Reconfigurable Switching Matrix,” which was filed on Jun. 5, 2001. The entire disclosure of U.S. Provisional Application No. 60/295,989 is hereby incorporated into the present application by reference.

### BACKGROUND

1. Field of the Invention

This invention relates generally to data communication networks. More particularly, the invention relates to network elements that employ a cross-connect switch matrix.

2. Description of the Related Art

Transport networks are well known in the data communication art. Transport networks include ATM networks, Frame Relay networks, the Synchronous Optical Network (“SONET”), Synchronous Digital Hierarchy (“SDH”) networks, and others. A transport network typically includes a plurality of network elements (elements) coupled together by one or more data communication channels (or paths). These network elements may, in turn, couple to local elements or networks, or may couple to other network structures.

In a SONET network, the basic transmission signal is referred to as the Synchronous Transport Signal level 1 (STS-1) signal. Higher level signals are referred to as STS-N signals, and are byte-interleaved multiples of the basic STS-1 level signal.

In an SDH network, the basic transmission signal is referred to as STM-1. An STM-1 signal has the same bandwidth as a SONET STS-3 signal. Higher level SDH signals are referred to as STM-N signals, and are byte-interleaved multiples of the basic STM-1 level signal.

Many of the network elements in the transport networks include switching hardware that are used to switch data from one data communication channel to another. The switching process in a network element is typically carried out using a hardware cross-connect switch matrix. The cross-connect switch matrix includes a plurality of input ports, a plurality of output ports, and a plurality of switches. In a network element in a SONET/SDH network, the cross-connect typically switches a plurality of input STS-N signals coupled to the input ports to a plurality of output STS-N signals on the output ports.

Switch matrices are well known in the art. Switch matrices are usually built to handle a certain type of payload. For example, when applied to a SONET or SDH type of payload, known switch matrices would typically switch STS-1 type signals, VT1.5 type signal, or other types of SONET/SDH type payloads, such as VC-4 or VC-12. These known switch matrices are limited to switching a particular payload type, and typically cannot be used to simultaneously switch different payload types or sizes. Thus, for example, a cross-connect switch matrix designed to switch SONET type payloads typically cannot also switch SDH type payloads.

Shown in FIG. 1 is an illustration of a known TSI based switch matrix 2. The known TSI based switch matrix 2 typically comprises an input channel 4, an output channel 6, a write engine 8, a buffer 10, a read engine 12, and a controller 14. The write engine 8 receives data or a payload from the input channel 4 and writes the payload or data to the buffer 10. The read engine 12 reads data from the buffer 10 and outputs the data via an output channel 6 to accomplish a time slot interchange (TSI) cross connection. The switch matrix control 14 controls the reading by the read engine 12 to the output channel 6. The channels are read out in a specific time slot to accomplish TSI cross-connection.

The known TSI based switch matrix 2 has the capability of switching a number of fixed size elements (e.g., the matrix can switch a number of STS-1, or VT1.5, or VC12 . . . elements). The control 14 only works with payloads having the same size. In a 2.5 Gbs switch matrix that is VT1.5 granular, such as a matrix that receives a STS-48 equivalent payload via the input channel, the control would view the matrix as having 1344 linear elements (48*28=1344 VT1.5 elements) that have to be TSI-ed (cross-connected) onto a set of 1344 linear output elements. In this example, the control 14 would generate a reading sequence that it provides to the read engine 12 for reading the 1344 VT1.5 elements out of the buffer 10 to the output channel 6 to accomplish the TSI switching. If part of the payload included VT2 elements, this VT1.5 granular switch matrix could not be used. The known switch matrix 2 is designed to operate on only a single payload type and size, and thus it cannot be used to simultaneously switch between different payload sizes (e.g., VT1.5 or VT2), or between different payload types (e.g., SONET and SDH). With this type of known switch matrix 2, the control 14 is essentially a lookup vector containing 1344 elements for an input bandwidth of 2.5 Gbs. The lookup vector represents the output sequence, spaced linearly in time.

### SUMMARY

An improved switch device is provided. The switch device has a switching matrix that is capable of switching signals of different payload and/or language types. In accordance with one aspect of the invention defined by the claims, the switch device comprises a switching matrix and a cross-connection controller. The switching matrix receives a quantity of data wherein the quantity of data includes a plurality of payloads. A first payload and a second payload of the plurality of payloads are of different sizes. The matrix is operable to switch the first and the second payloads. The cross-connection controller provides switching instructions to the switching matrix. The controller receives payload identification information and connection point information and generates switching instructions in response to the payload identification information and the connection point information. The switching instructions are provided to the matrix to instruct the matrix on how to switch the first and second payloads.

In accordance with another aspect of the invention defined by the claims, a switch device is provided that comprises a switching matrix and a cross-connection controller. The switching matrix receives a quantity of data, divides the received data into a plurality of unit blocks, and assigns a unit block address to each unit block. The switching matrix is operable to output the unit blocks in an order that is different from the order in which the unit blocks were received by the switching matrix. The switching matrix is provided with the order in which to output the unit blocks. The cross-connection controller determines the output order for the unit blocks. The cross-connection controller receives a first input vector and a second input vector. The first input vector provides size and type information relating to the quantity of data that allows the cross-connection controller to group the unit blocks into one or more payload groupings. The second input vector provides information relating to a time slot for outputting each payload grouping. The controller is operable to determine the order in which to output the unit blocks based on the desired time slot for outputting each payload grouping.

In accordance with another aspect of the invention defined by the claims, a network element that has a plurality of switching devices is provided wherein at least one of the switching devices comprises a switching matrix and a cross-connection controller. The switching matrix receives a quantity of data, divides the received data into a plurality of unit blocks, and assigns a unit block address to each unit block. The switching matrix is operable to output the unit blocks in an order that is different from the order in which the unit blocks were received by the switching matrix. The switching matrix is provided with the order in which to output the unit blocks. The cross-connection controller determines the output order for the unit blocks. The cross-connection controller receives a first input vector and a second input vector. The first input vector provides size and type information relating to the quantity of data that allows the cross-connection controller to group the unit blocks into one or more payload groupings. The second input vector provides information relating to a time slot for outputting each payload grouping. The controller is operable to determine the order in which to output the unit blocks based on the desired time slot for outputting each payload grouping.

### BRIEF DESCRIPTION OF THE DRAWINGS

In order that the invention identified in the claims may be more clearly understood, preferred embodiments of structures, systems and methods having elements corresponding to elements of the invention recited in the claims will be described in detail by way of example, with reference to the accompanying drawings, in which:

FIG. 1 sets forth a block diagram of a known TSI switch matrix;

FIG. 2 is a schematic diagram of an exemplary transport network comprising two types of ring networks;

FIG. 3 is a block diagram of a preferred cross-connect system having a preferred column based switching matrix;

FIG. 4 is a block diagram of a preferred column based switching matrix;

FIG. 5 is a block diagram of a preferred cross-connect controller for the preferred switch matrix;

FIG. 6 is a schematic representation of preferred input and output vectors used with the preferred cross-connect controller; and

FIG. 7 is a schematic representation of the relationships between the preferred input and output vectors and the blocks that make up those vectors.

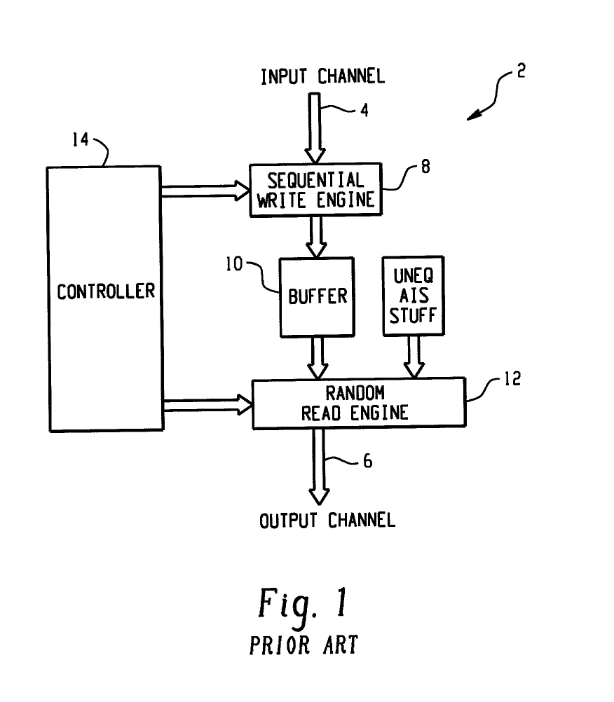

### DETAILED DESCRIPTION

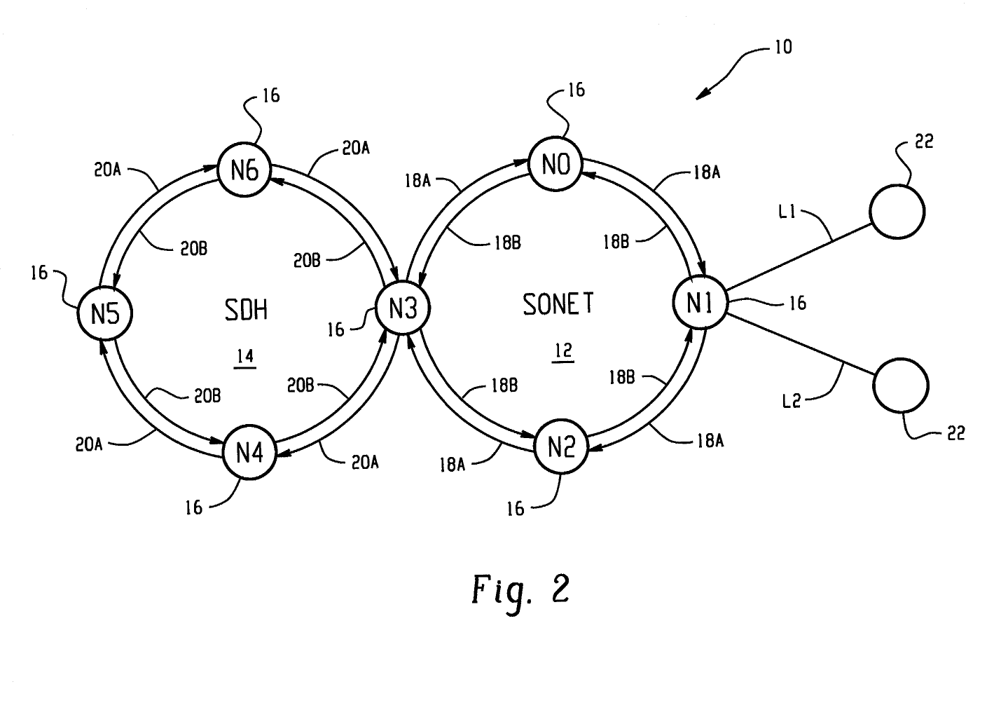

Turning now to the drawing figures, FIG. 2 sets forth a system diagram of an exemplary transport network 10. The transport network 10 shown includes two ring networks 12 and 14. The first ring network 12 is a SONET network and the second ring network 14 is an SDH network. Each ring network 12 and 14 includes a plurality of network elements, labeled N0-N6, coupled in the ring structures by one or more communication paths 18A, 18B, 20A, 20B. As shown in FIG. 2, the two paths 18A, 18B transport a plurality of SONET STS-1 (or STS-N) data streams in opposite directions about the SONET ring 12, and the two paths 20A, 20B transport a plurality of SDH STM-1 (or STM-N) data streams in opposite directions about the SDH ring 14. The communication paths 18A, 18B, 20A, 20B are preferably fiber optic connections (in SONET and SDH), but could, alternatively be electrical paths or even wireless connections (in other types of networks). In the case of a fiber optic connection, paths 18A, 18B could be implemented on a single fiber 18, on dual fibers 18A, 18B, or some other combination of connections. Also, paths 20A, 20B could be implemented on a single fiber 20, on dual fibers 20A, 20B, or some other combination of connections. In the dual fiber implementation, one of the fibers could be the working ring, and the other fiber could be the protection ring.

In each ring 12, 14, preferably each network element 16 is coupled to two other network elements 16 in the ring structure. For example, network element N0 is coupled to network elements N1 and N3. The coupling between the elements in FIG. 2 is two-way meaning that each element 16 transmits and receives signals to and from each of the two other elements 16 to which it is connected. Each network element 16 includes at least two transmitter/receiver interfaces, one for each connection to another element 16. The network elements 16 could be many types of well-known network devices, such as a digital cross-connect system (“DCCS”), an Add-Drop Mux (“ADM”), switch, router, or other type of device.

The network devices 16 shown in FIG. 2 are preferably DCCSs. A DCCS is a device having an upstream network element interface, a downstream network element interface, and an add/drop interface. These DCCSs 16 are coupled to local elements 22, and are used to add signals to the network data traffic from the local elements 22 and, conversely, to drop data signals from the network data traffic to the local elements 22. The switching, adding and dropping operations of the DCCS 16 are typically performed by one or more hardware cross-connect switching system cards having one or more hardware cross connect switching matrices.

One network element in FIG. 2, network element N3, is coupled to two network elements in each ring 12, 14. This network element N3 must be capable of passing traffic between each ring 12, 14. Consequently, this network element has a cross-connect system and/or a cross connect switch matrix that is capable of switching traffic between each of the transport network types.

Another network element in FIG. 2, network element N1, is coupled to two local connections L1 and L2. Local connection L1 is an DS-1 line that provides a VT1.5 payload to ring 12. Local connection L2 is a E1 line that provides VT2 payload to ring 12. This network element N1 must be capable of passing traffic between ring 12 and Local loop L1 and between ring 12 and local loop L2. Consequently, this network element has a cross-connect system and/or a cross connect switch matrix that is capable of switching traffic of different sizes using a single cross connect matrix.

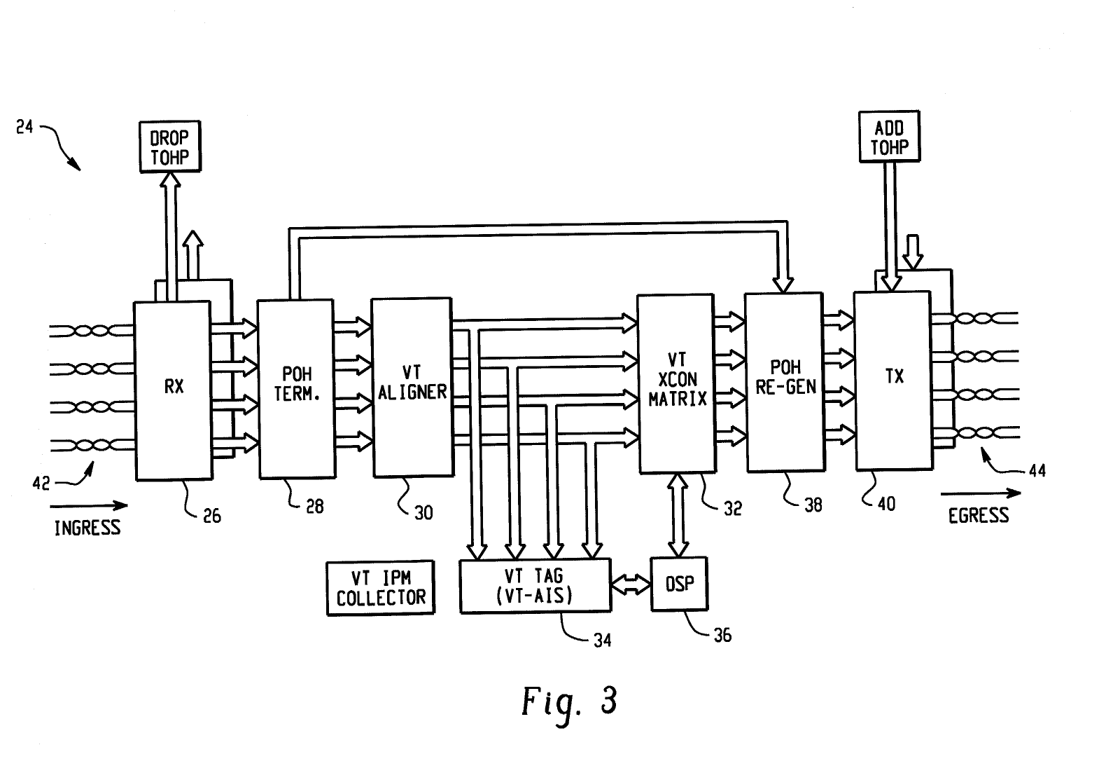

FIG. 3 is a block diagram of an exemplary cross-connect system 24 in a network element that is capable of switching traffic having payloads of different types and/or sizes.

The exemplary cross-connect system 24 comprises a receiver 26, a path overhead terminator 28, a virtual tributary aligner 30, a virtual tributary cross-connect matrix 32, a virtual tributary defect assessor (Quality-TAG) 34, a processor 36, a path overhead regenerator 38, and a transmitter 40.

In this implementation, the receiver 26 receives data, e.g. at 622 Mbs, via input ports 42 and converts the 622 Mbs signal to a signal that can be processed by standard logic. The converted signals are passed to the POH terminator 28. The POH terminator 28 terminates the high order path for low bandwidth signals, (e.g. VTx and VCx), and simply passes through higher bandwidth signals, e.g. STS-1 or STM-1, that are within the received converted signals, as specified in GR-253-CORE for SONET and in ITU-T G.707 for SDH. The VT aligner receives the output from the POH terminator 28, and adjusts the columns of the signals to the same frequency, and aligns the column boundary. The VT TAG 34 extract the quality of the signal output by the VT aligner 30. The cross-connect matrix 32 performs a TSI switching function on the signal output by the VT aligner 30 under the control of the processor 36.

The VT XCON matrix is the actual column-based non-blocking switch that can cross-connect any in-coming VT/VC to any outgoing VT/VC. The total bandwidth capacity of the matrix is 2.4 Gbps in this example. After leaving the cross connect matrix, the POH Re-Generator 38 creates the POH column for each of the outgoing streams as specified in GR-253-CORE for SONET and in ITU-T G.707 for SDH. The transmitter 40 converts the output of the POH Re-Generator 38 to an appropriate output stream and presents the output stream at output ports 44.

Preferred Switching Device

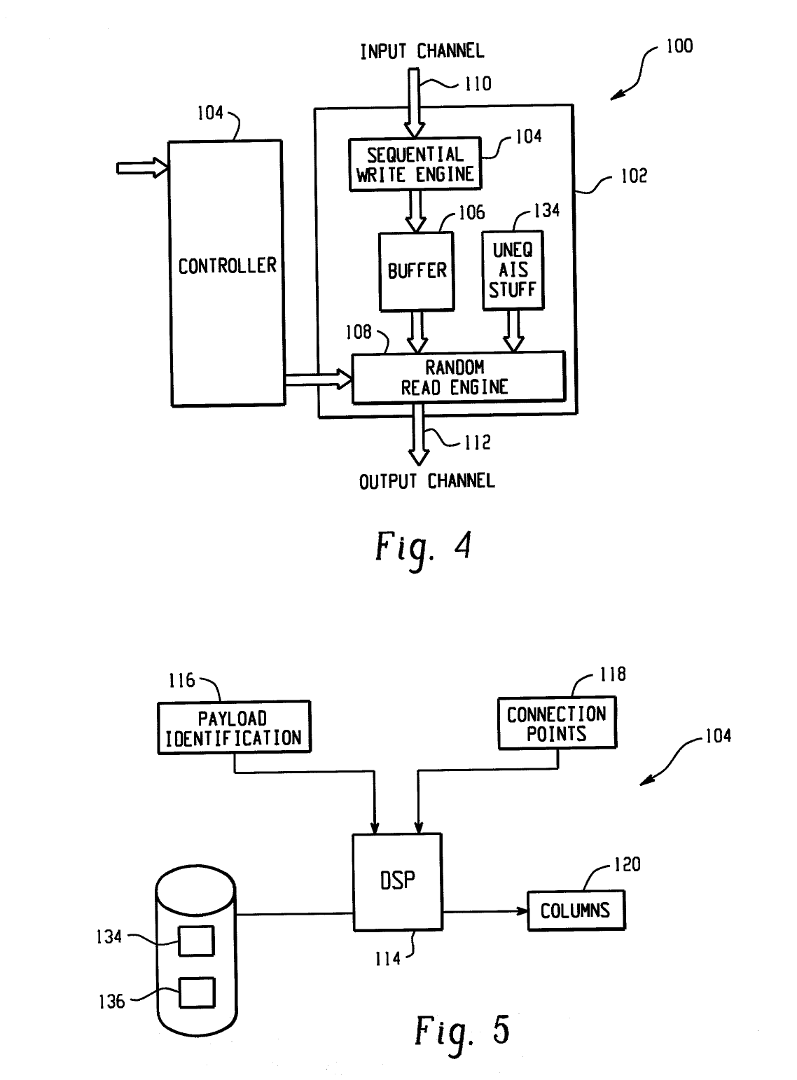

FIG. 4 depicts a preferred switching device 100. The preferred switching device 100 is a column-based reconfigurable switching matrix comprising a physical matrix 102 and a cross-connection controller 104. The switching device 100 is capable of simultaneously switching signals of multiple payload type and/or size. For example, the preferred switching device 100 is capable of simultaneously switching signals of multiple payload types such as simultaneously switching both SONET and SDH signals. The preferred switching device 100 is capable of simultaneously switching signals of multiple payload sizes such as simultaneously switching VT1.5 and VT2 signals. The preferred switching device 100 is also capable of simultaneously switching signals of multiple payload types and sizes such as simultaneously switching SDH VC11 signals and SONET VT6 signals.

The preferred switching matrix 102 is capable of switching on a column by column basis, which allows it to switch signals of multiple payload type and/or size. The preferred switching matrix 102 comprises a write engine 104, a buffer or memory 106, and a read engine 108. The write engine 104 receives traffic or payload from an input channel 110 and writes the payload or data to the buffer 106 preferably in a sequential manner. The switching matrix 102 also preferably assigns a column address to each column of data written into the buffer 106. The read engine 108 reads data from the buffer 106 preferably on a channel by channel basis in a predetermined order and outputs the data via an output channel 112 to accomplish a time slot interchange (TSI) cross connection. The cross-connection controller 104 preferably provides the read engine 108 with the channel by channel order in which to read the data out of the buffer 106 by providing the channel addresses in the order in which the channels are to be read. The channels are read out in a specific time slot to accomplish TSI cross-connection.

With reference to FIG. 5, the cross-connection controller 102 preferably comprises some type of control hardware 114 such as a DSP although other devices such as a microprocessor, controller, micro-controller, programmable logic device, or others could be used. The control hardware 114 is preferably provided with two input vectors 116, 118 and generates an output vector 120 based on the input vectors 116, 118 and its knowledge of the how the read engine 108 writes data into the buffer 106.

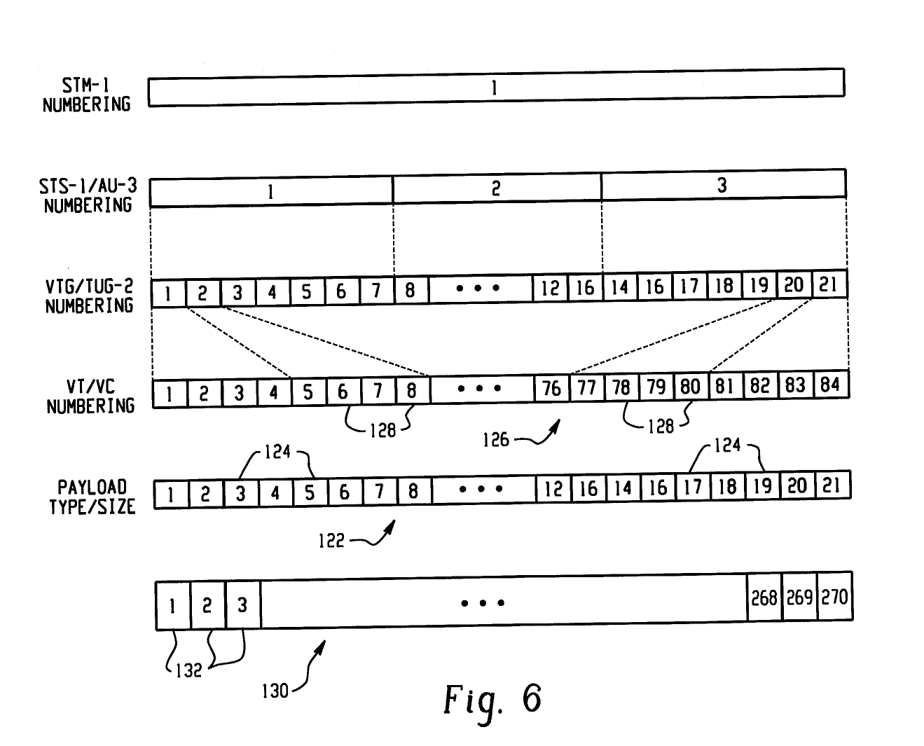

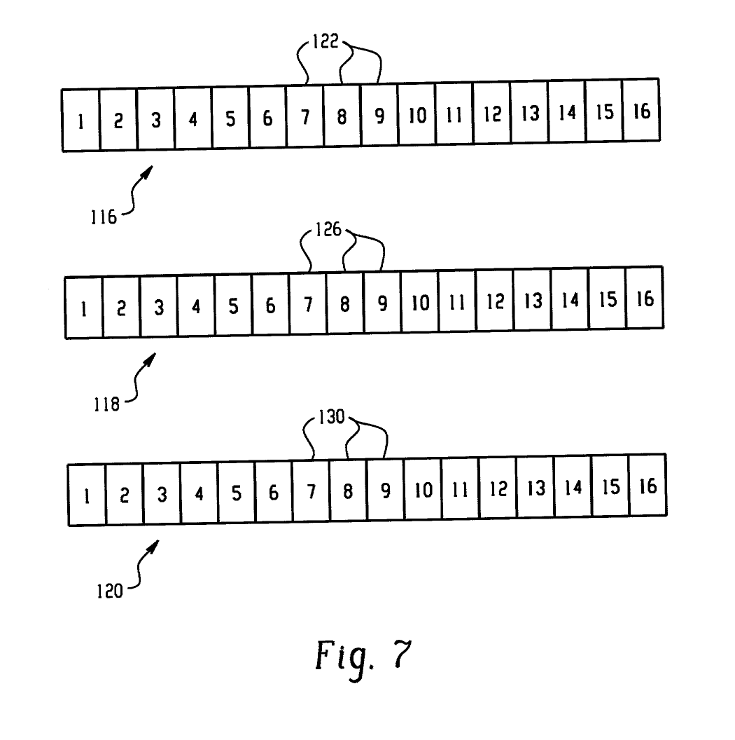

The first input vector 116 is a payload identification input vector. This vector contains information relating to the payload that is written into buffer 106. The switch matrix controller 104 performs its calculations based on a basic building block for the payload. The basic building block is the smallest basic payload size that is common to the types of signals that are to be switched. For the preferred switching device 100, which can switch both SDH and SONET signals, the basic building block is a STM-1 frame because it is the smallest higher order payload size that is common to both SDH and SONET. The payload identification input vector 116 contains one or more payload identification blocks 122 (as illustrated in FIG. 6) wherein each payload identification block 122 contains identification information for one basic building block slice (STM-1 frame slice in this example) of the payload that is stored in the buffer 106. The total number of payload identification blocks 122 in the payload identification input vector 116 is equal to the total number of payload building blocks needed to describe the entire payload in the buffer 106. For example, for a switching device that can switch four STS-12 signals or 2.5 GBS, the payload identification input vector 116 would contain 16 payload identification blocks 122 (as illustrated in FIG. 7) wherein each identification block 122 would describe one STM-1 slice of payload.

An exemplary payload identification block 122 is illustrated in FIG. 6. The payload identification block 122 is subdivided into a plurality of payload description channels 124. The number of payload description channels 124 is determined by the maximum number of possible lower rate signal groups that could be supported by the basic building block. In this example, because the basic building block is a STM-1 frame slice, the number of payload description channels 124 is 21 because the maximum number of lower rate signal groups that could be multiplexed into an STM-1 signal is 21 virtual tributary (VT) groups in the case of SONET or 21 tributary unit group level 2 (TUG-2) groups in the case of SDH.

The payload description channels 124 collectively describe the portion of the payload the payload identification block 122 relates to. Not all of the payload description channels 124 may contain identification information. The first payload description channel 124 describes the first section of the relevant payload portion. The next payload description channel 124 that has applicable identification information is determined based on the size of the last described payload section. For example, if the first payload description channel 124 identified the payload as a SDH STM-1 signal then none of the remaining payload description channels 124 in that payload identification block 122 would have applicable information because the STM-1 signal would use the entire bandwidth that could be described by the payload identification block 122. If the first payload description channel 124 identified the payload as a SONET STS-1 signal, then the next applicable payload description channel 124 would be payload description channel No. 8 because a STS-1 signal would use the bandwidth that could be described by payload description channels 1-7. If the first payload description channel 124 identified the payload as a SONET VT1.5 signal, then the next applicable payload description channel would be payload description channel No. 2 because a VT1.5 signal would be contained in a single lower rate signal group and each channel 124 represents the bandwidth for a signal group.

The second input vector 118 is a connection point vector. The connection point vector 118 contains connection point information that identifies the time slot in which the payload sections identified by the payload identification blocks 122 are to be outputted. The output of the switching device 100 can be viewed as consisting of a plurality of time slots. Cross connection is accomplished by the switching device 100 by outputting a specific payload section that is received in the input channel in an appropriate time slot in the output channel.

The connection point vector 118 contains one or more connection point blocks 126. For example, for a switching device that can switch four STS-12 signals or 2.5 GBS, the connection point vector 118 would contain 16 connection point blocks 126 (as illustrated in FIG. 7) wherein each connection point block 126 contains information for one basic building block slice (STM-1 frame size in this example) of the payload that is stored in buffer 106. As illustrated in FIG. 6, each connection point block 126 contains a plurality of connection point block channels 128, the number of connection point block channels 128, being determined by the maximum number of possible virtual tributary groups (VTGs) or TUG-2 groups times the maximum number of virtual tributaries (VTs) or virtual containers (VCs) that could be supported by a VTG/TUG-2. In this example, each connection point block 126 contains 84 connection point block channels 128 wherein each group of four channels correspond to a VTG/TUG-2. Therefore, there are 84 possible cross-connections out of an STM-1 slice of bandwidth.

The output vector 120 preferably is an output column vector. The output column vector 120 preferably includes a plurality of column vector blocks 130. For example, for a switching device that can switch four STS-12 signals or 2.5 GBS, the output column vector 120 would contain 16 column vector blocks 130 (as illustrated in FIG. 7) wherein each column vector block 130 contains information for one basic building block slice (STM-1 frame slice in this example) of the payload that is stored in buffer 106. Each column vector block 130 includes a plurality of column vector block columns 132 wherein the number of column vector block columns 132 is equal to the total number of columns in a buffer unit slice of payload. In this example there are 270 column vector block columns 132 because there are 270 columns of data in a STM-1 data frame.

The controller 114 populates each column vector block column 132 with a column address that corresponds to a column of data in buffer 106. The order of the column addresses in the column vector blocks 130 determines the order in which the columns of data are read out of buffer 106. As a column of data is read out of the buffer 106, it is assigned to the next output time slot. By determining the order in which the columns of data are read out of buffer 106, the controller 104 can determine the time slot each column of data is assigned to thereby controlling the time slot interchange the switching device 100 performs.

The cross-connection controller 104 also preferably includes programming 134 and lookup tables 136 that instruct the DSP 114 on how to use the first and second input vectors 116, 118 to perform the translation necessary to generate the output vector 120. The translation from the payload description to the output column address sequence is preferably accomplished through the use of a couple of lookup table stages especially since the various payloads do not occupy consecutive column numbers.

In operation, as payload is written into buffer 106 the DSP 114 examines the payload identification input vector 116 to determine the payload type/size for the incoming payload. The DSP 114 then examines the connection point vector 118 to determine how the payload is to be cross-connected.

If, for example, the first STM-1 slice of payload is described as an STM-1 slice, then the DSP 114 looks only at connection point block channel no.1 to identify the time slot in which this STM-1 slice is to be cross-connected to. After identifying the output time slot, the DSP 114 determines the appropriate column address sequence needed to direct this STM-1 slice to its assigned output time slot and writes this column address sequence to the output column vector 120 at columns 1-270, in the appropriate column vector block 130.

Alternatively, if the first payload section in the first STM-1 slice is described as a STS-1 slice, then the DSP 114 would look at connection block channel no. 1 to identify the time slot in which the STS-1 slice would be cross-connected to. After identifying the output time slot, the DSP 114 determines the appropriate column address sequence needed to direct the STS-1 slice to its assigned output time slot and writes this column address sequence to the output column vector 120 in columns 1-90 in the appropriate column vector block 130.

The DSP 114 would next look at payload description channel no. 8 to find the description for the next slice of bandwidth within the STM-1 slice (because the prior STS-1 slice occupied payload description channel nos. 1-7). If this slice is also described as an STS-1 slice, the DSP 114 would look at connection block channel no. 29 to identify the time slot in which this STS-1 slice would be cross-connected to (because the prior STS-1 slice occupied connection block channel nos. 1-28). After identifying the output time slot, the DSP 114 determines the appropriate column address sequence needed to direct the STS-1 slice to its assigned output time slot and writes this column address sequence to the output column vector 120 in columns 91-180 in the appropriate column vector block 130.

The DSP 114 would then look at payload description channel no. 15 to find the description for the next slice of bandwidth within the STM-1 slice (because the prior STS-1 slice occupied payload description channel nos. 8-14). If this slice is described as an VT-6 slice, the DSP 114 would look at connection block channel no. 57 to identify the time slot in which the VT-6 slice would be cross-connected to (because the prior STS-1 slice occupied connection block channel nos. 29-56). After identifying the output time slot, the DSP 114 determines the appropriate column address sequence needed to direct the VT-6 slice to its assigned output time slot and writes this column address sequence to the output column vector 120 in columns 181-192.

The DSP 114 would then look at payload description channel no. 16 to find the description for the next slice of bandwidth within the STM-1 slice (because the prior VT-6 slice occupied payload description channel no. 15). If this slice is also described as an VT-6 slice, the DSP 114 would look at connection block channel no. 61 to identify the time slot in which the VT-6 slice would be cross-connected to (because the prior VT-6 slice occupied connection block channel nos. 57-60). After identifying the output time slot, the DSP 114 determines the appropriate column address sequence needed to direct the VT-6 slice to its assigned output time slot and writes this column address sequence to the output column vector 120 in columns 193-204.

This process of examining the payload description channels 124 and connection block channels 128, determining the appropriate column address sequence, and writing the column address sequence to the output column vector 120 is repeated until the remainder of the STM-1 bandwidth slice has been operated on. This process is performed for each STM-1 slice within the total payload in buffer 106. The read engine 108 in the hardware switch matrix 102 would then read out the columns from the buffer 106 into the output channel 112 in the appropriate output time slot based on the order provided in the output column vector 120 to accomplish the TSI switching.

The switching device 100 uses real SONET/SDH column numbering. An STM-1 is formed of 270 columns and therefore each STM-1 slice of payload requires 270 column vector block columns 132 in the output column vector 120. A VT1.5/VC11 signal would occupy 3 of those columns 132. A VT2/VC12 would occupy 4 of those columns 132. A VT3 would occupy 6 of those columns 132. A VT6 would occupy 12 of those columns 132. A STS-1/AU3 would occupy 90 of those columns 132. And, an STM-1/AU-4 would occupy all 270 of those columns 132.

Also, the switching device 100 can generate AIS and UNEQ for all of the known payload types when AIS or UNEQ is to be injected, negative connection numbers are provided in the connection point vector to appropriately instruct the controller 104. The controller 104 would cause AIS or UNEQ payload to be fetched from the AIS/UNEQ block 134, instead of the TSI memory block 106.

Some embodiments of the switching device 100 can be used to implement a multi-language, multi-service central cross-connect. Some embodiments are not specific to a certain payload language, or size, as long as it is column based (as SONET and SDH are). Some embodiments are easy to control from the software point of view, as its control mechanism deals with payload type, size and number, i.e. a direct representation of what the user would tell the matrix. And, in some embodiments, the complexity of the control is hidden by a hardware layer that translate payload descriptions into “real work”.

Conclusion

Other variations from these systems and methods should become apparent to one of ordinary skill in the art without departing from the scope of the invention defined by the claims. The preferred embodiments have been described with reference to SONET/SDH network systems but the invention described by the claims could be applicable to other network systems.

The embodiments described herein and shown in the drawings are examples of structures, systems or methods having elements corresponding to the elements of the invention recited in the claims. This written description and drawings may enable those skilled in the art to make and use embodiments having alternative elements that likewise correspond to the elements of the invention recited in the claims. The intended scope of the invention thus includes other structures, systems or methods that do not differ from the literal language of the claims, and further includes other structures, systems or methods with insubstantial differences from the literal language of the claims. It is also to be understood that the invention is not limited to use with SONET or SDH systems unless explicitly limited by the claims.

The following is claimed:

1. A switch device comprising:
a switching matrix that receives a quantity of data, divides the received data into a plurality of unit blocks, and assigns a unit block address to each unit block, the switching matrix being operable to output the unit blocks in an order that is different from the order in which the unit blocks were received, the switching matrix being provided with the order in which to output the unit blocks; and
a cross-connection controller for determining the output order for the unit blocks, the cross-connection controller receiving a first input vector and a second input vector, the first input vector providing size and type information relating to the quantity of data that allows the cross-connection controller to group the unit blocks into one or more payload groupings, the second input vector providing information relating to a time slot for outputting each payload grouping, the controller being operable to determine the order in which to output the unit blocks based on the desired time slot for outputting each payload grouping.

2. The switch device of claim 1 wherein the unit block is a column of SONET and/or SDH data.

3. The switch device of claim 1 wherein the quantity of data is one or more frames of STM-1 data.

4. The switch device of claim 1 wherein the quantity of data is one or more frames of STS-1 data.

5. The switch device of claim 1 wherein the switch matrix controller communicates the order in which to output the unit blocks to the switch matrix via an output vector that contains unit block addresses in the order that the unit blocks are to be outputted.

6. The switch device of claim 1 wherein the first input vector is a payload identification input vector and the second input vector is a connection point vector, the payload identification input vector having a plurality of payload description channels, the number of payload description channels corresponding to the largest possible number of tributaries for the smallest common building block size for the input signals, the connection point vector divided into a fixed number of output time slots, the number of output time slots corresponding to the maximum number of time slots possible for the smallest common building block size for the input signals.

7. The switch device of claim 6 wherein the smallest common building block size is an STM-1 frame, the number of input tributary slots is 21, and the number of output time slots is 84.

8. The switch device of claim 1 wherein the payload groupings are selected from a set comprising: STS-1, STM-1, VT1.5, VT2, VT3, VT6, AU3, AU4, VC11, and VC12 bandwidth groupings.

9. The switch device of claim 1 wherein the cross-connection controller comprises a DSP.

10. A switch device comprising:
a switching matrix that receives a quantity of data wherein the quantity of data includes a plurality of payloads wherein a first and a second payload of the plurality of payloads are of different bandwidth, the matrix being operable to switch the first and the second payload; and
a cross-connection controller for providing switching instructions to the switching matrix, the controller receiving payload identification information and connection point information and generating switching instructions in response to the payload identification information and the connection point information, the switching instructions instructing the matrix on how to switch the first and second payloads.

11. The switch device of claim 10 wherein the cross-connection controller comprises a DSP.

12. The switch device of claim 10 wherein the first and second payloads are of different signal types.

13. The switch device of claim 12 wherein the first payload is a SONET payload and the second payload is an SDH payload.

14. The switch device of claim 10 wherein the first and second payloads are of the same signal type.

15. The switch device of claim 10 wherein the switch matrix divides the received data into a plurality of unit blocks, assigns a unit block address to each unit block, and is operable to output the unit blocks in an order that is different from the order in which the unit blocks were received.

16. The switch device of claim 15 wherein the cross-connection controller determines the output order for the unit blocks, the cross-connection controller being operative to group the unit blocks into one or more payload groupings, the controller being operable to determine the order in which to output the unit blocks based on a desired time slot for outputting each payload grouping.

17. A network element having a plurality of switching devices wherein at least one of the switching devices comprises:
a switching matrix that receives a quantity of data wherein the quantity of data includes a plurality of payloads wherein a first and a second payload of the plurality of payloads are of different bandwidth, the matrix being operable to switch the first and the second payload; and
a cross-connection controller for providing switching instructions to the switching matrix, the controller receiving payload identification information and connection point information and generating switching instructions in response to the payload identification information and the connection point information, the switching instructions instructing the matrix on how to switch the first and second payloads.

18. The network element of claim 17 wherein the switch matrix divides the received data into a plurality of unit blocks, assigns a unit block address to each unit block, and is operable to output the unit blocks in an order that is different from the order in which the unit blocks were received.

19. The network element of claim 18 wherein the cross-connection controller determines the output order for the unit blocks, the cross-connection controller being operative to group the unit blocks into one or more payload groupings, the controller being operable to determine the order in which to output the unit blocks based on a desired time slot for outputting each payload grouping.

20. The network element of claim 17 wherein the first and second payloads are of different signal types.
